(19) United States
(12) Patent Application Publication
(10) Pub. No.: US 2024/0013728 A1
(43) Pub. Date: Jan. 11, 2024

(54) DISPLAY DEVICE AND METHOD OF DRIVING THE SAME

(71) Applicant: Samsung Display Co., Ltd., Yongin-si (KR)

(72) Inventors: DONGGYU LEE, Yongin-si (KR); JIN-WOOK YANG, Suwon-si (KR); JAE-HYEON JEON, Seoul (KR)

(21) Appl. No.: 18/106,008

(22) Filed: Feb. 6, 2023

(30) Foreign Application Priority Data
Jul. 11, 2022 (KR) 10-2022-0085070

(51) Int. Cl. G09G 3/3266; G09G 3/3233

(52) U.S. Cl. CPC G09G 3/3266; G09G 3/3233; G09G 2300/0819; G09G 2300/0842; G09G 2300/0861; G09G 2310/08; G09G 2320/02; G09G 2340/0435

(57) ABSTRACT

A display device includes a display panel including pixels, and a display panel driver which starts a scan operation in synchronization with an input timing of input image data, performs the scan operation every a scan cycle in one frame, and delays a start of the scan operation of an (N+1)-th frame until the scan operation of an N-th frame ends when the input image data of the (N+1)-th frame is input during the scan operation of the N-th frame, where N is a positive integer.

This application claims priority to Korean Patent Application No. 10-2022-0085070, filed on Jul. 11, 2022, and all the benefits accruing therefrom under 35 U.S.C. § 119, the content of which in its entirety is herein incorporated by reference.

### BACKGROUND

### 1. Field

Embodiments of the invention relate to a display device and a method of driving the display device. More particularly, embodiments of the invention relate to a display device in which a driving frequency of a display panel is varied and a method of driving the display device.

### 2. Description of the Related Art

Generally, a display device may include a display panel, a timing controller, gate driver, and a data driver. The display panel may include a plurality of gate lines, a plurality of data lines, and a plurality of pixels electrically connected to the gate lines and the data lines. The gate driver may provide gate signals to the gate lines. The data driver may provide data voltages to the data lines. The timing controller may control the gate driver and the data driver.

The display device may display an image at a constant driving frequency of 60 Hz or higher. However, a rendering frequency of rendering by a host processor (e.g., a graphic processing unit; GPU) that provides input image data to the display device may not match a driving frequency of the display device.

### SUMMARY

In a display device, when a rendering frequency of rendering by a host processor does not match a driving frequency of the display device, and a tearing phenomenon in which a boundary line is recognized in the image displayed on the display device may occur due to frequency mismatch.

Accordingly, a variable frame mode for synchronizing the rendering frequency of the host processor and the driving frequency of the display device may be used to prevent such the tearing phenomenon.

However, the display device operating in the variable frame mode may vary the driving frequency by varying the number of scan operations performed in one frame. Therefore, an expressible driving frequency may be limited.

Embodiments of the invention provide a display device that synchronizes a driving frequency of a display panel with an input frequency of input image data.

Embodiments of the invention also provide a method of driving the display device.

According to embodiments of the invention, a display device includes a display panel including pixels, and a display panel driver which starts a scan operation in synchronization with an input timing of input image data, performs the scan operation every a scan cycle in one frame, and delays a start of the scan operation of an (N+1)-th frame until the scan operation of an N-th frame ends when the input image data of the (N+1)-th frame is input during the scan operation of the N-th frame, where N is a positive integer.

In an embodiment, the display panel driver may delay a start of the scan operation of an (N+2)-th frame until a frame time of the (N+1)-th frame ends when the input image data of the (N+2)-th frame is input in the (N+1)-th frame in which the start of the scan operation is delayed.

In an embodiment, the display panel driver may perform the scan operation and a light emission operation to drive the display panel in the one frame.

In an embodiment, the scan cycle may be a period obtained by dividing a period of a frame driven at a maximum driving frequency by M, where M is a positive integer.

In an embodiment, the scan cycle when an input frequency of the input image data is a first frequency may be shorter than the scan cycle when the input frequency is a second frequency different from the first frequency.

In an embodiment, the first frequency may be greater than a first reference frequency and less than or equal to a second reference frequency, which is greater than the first reference frequency, and the second frequency may be less than or equal to the first reference frequency, or greater than the second reference frequency.

In an embodiment, the scan operation first performed in the one frame may be a display scan operation in which data voltages are written to the pixels, and the scan operation in the one frame excluding the display scan operation may be a self-scan operation in which the data voltages are not written to the pixels.

In an embodiment, each of the pixels includes a first transistor including a control electrode connected to a first node, a first electrode connected to a second node, and a second electrode connected to a third node, a second transistor including a control electrode which receives a write gate signal, a first electrode which receives the data voltages, and a second electrode connected to the second node, a third transistor including a control electrode which receives the write gate signal, a first electrode connected to the third node, and a second electrode connected to the first node, a fourth transistor including a control electrode which receives an initialization gate signal, a first electrode which receives an initialization voltage, and a second electrode connected to the first node, a fifth transistor including a control electrode which receives an emission signal, a first electrode which receives a first power voltage, and a second electrode connected to the second node, a sixth transistor including a control electrode which receives the emission signal, a first electrode connected to the third node, and a second electrode connected to a fourth node, a seventh transistor including a control electrode which receives a bias gate signal, a first electrode which receives the initialization voltage, and a second electrode connected to the fourth node, a storage capacitor including a first electrode which receives the first power voltage and a second electrode connected to the first node, and a light emitting element including a first electrode connected to the fourth node and a second electrode which receives a second power voltage.

In an embodiment, the emission signal may have a inactivation level in the scan operation and an activation level in a light emission operation.

In an embodiment, the write gate signal and the initialization gate signal may have an activation level period in the display scan operation and an inactivation level in the self-scan operation, and the bias gate signal may have an activation level period in the display scan operation and the self-scan operation.

According to embodiments of the invention, a display device includes a display panel including pixels, and a display panel driver which starts a scan operation in synchronization with an input timing of input image data, performs the scan operation every a scan cycle in one frame, and starts the scan operation of an (N+1)-th frame when the input image data of the (N+1)-th frame is input during the scan operation of an N-th frame, where N is a positive integer.

In an embodiment, the display panel driver may perform the scan operation and a light emission operation to drive the display panel in the one frame.

In an embodiment, the scan cycle may be a period obtained by dividing a period of a frame driven at a maximum driving frequency by M, where M is a positive integer.

In an embodiment, the scan cycle when an input frequency of the input image data is a first frequency may be shorter than the scan cycle when the input frequency is a second frequency different from the first frequency.

In an embodiment, the first frequency may be greater than a first reference frequency and less than or equal to a second reference frequency, which is greater than the first reference frequency, and the second frequency may be less than or equal to the first reference frequency or greater than the second reference frequency.

In an embodiment, the scan operation first performed in the one frame may be a display scan operation in which data voltages are written to the pixels, and the scan operation in the one frame excluding the display scan operation may be a self-scan operation in which the data voltages are not written to the pixels.

In an embodiment, each of the pixels includes a first transistor including a control electrode connected to a first node, a first electrode connected to a second node, and a second electrode connected to a third node, a second transistor including a control electrode which receives a write gate signal, a first electrode which receives the data voltages, and a second electrode connected to the second node, a third transistor including a control electrode which receives the write gate signal, a first electrode connected to the third node, and a second electrode connected to the first node, a fourth transistor including a control electrode which receives an initialization gate signal, a first electrode which receives an initialization voltage, and a second electrode connected to the first node, a fifth transistor including a control electrode which receives an emission signal, a first electrode which receives a first power voltage, and a second electrode connected to the second node, a sixth transistor including a control electrode which receives the emission signal, a first electrode connected to the third node, and a second electrode connected to a fourth node, a seventh transistor including a control electrode which receives a bias gate signal, a first electrode which receives the initialization voltage, and a second electrode connected to the fourth node, a storage capacitor including a first electrode which receives the first power voltage and a second electrode connected to the first node, and a light emitting element including a first electrode connected to the fourth node and a second electrode which receives a second power voltage.

In an embodiment, the emission signal may have a inactivation level in the scan operation and an activation level in a light emission operation.

In an embodiment, the write gate signal and the initialization gate signal may have an activation level period in the display scan operation and an inactivation level in the self-scan operation, and the bias gate signal may have the activation level period in the display scan operation and the self-scan operation.

According to embodiments of the invention, a method of driving a display device includes starting a scan operation in synchronization with an input timing of input image data, performing the scan operation every a scan cycle in one frame, delaying a start of the scan operation of an (N+1)-th frame until the scan operation of an N-th frame ends when the input image data of the (N+1)-th frame is input during the scan operation of the N-th frame, where N is a positive integer.

In embodiments of the invention, as described herein, the display device may synchronize a driving frequency of a display panel with an input frequency of input image data by starting a scan operation in synchronization with an input timing of the input image data, performing the scan operation every a scan cycle in one frame, and delaying a start of the scan operation of an (N+1)-th frame until the scan operation of an N-th frame ends when the input image data of the (N+1)-th frame is input during the scan operation of the N-th frame. Accordingly, an expressible driving frequency of the display device may be expanded or less limited.

In embodiments of the invention, the display device may save memory usage by starting a scan operation in synchronization with an input timing of input image data, performing the scan operation every a scan cycle in one frame, and starting the scan operation of an (N+1)-th frame when the input image data of the (N+1)-th frame is input during the scan operation of an N-th frame.

### BRIEF DESCRIPTION OF THE DRAWINGS

FIG. 1 is a block diagram illustrating a display device according to embodiments of the invention.

FIG. 2 is a circuit diagram illustrating an embodiment of pixels of the display device of FIG. 1.

FIG. 3 is a diagram illustrating an example in which the display device of FIG. 1 varies a driving frequency.

FIG. 4 is a signal timing diagram illustrating an example in which the display device of FIG. 1 performs a display scan operation.

FIG. 5 is a signal timing diagram illustrating an example in which the display device of FIG. 1 performs a self-scan operation.

FIG. 6 is a diagram illustrating an example in which a display device varies a driving frequency according to embodiments of the invention.

FIG. 7 is a diagram illustrating an example of a scan cycle of a display device according to embodiments of the invention.

FIG. 8 is a graph illustrating an example of luminance according to a driving frequency.

FIG. 9 is a flowchart illustrating a method of driving a display device according to embodiments of the invention.

FIG. 10 is a block diagram showing an electronic device according to embodiments of the invention.

FIG. 11 is a diagram showing an embodiment in which the electronic device of FIG. 11 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

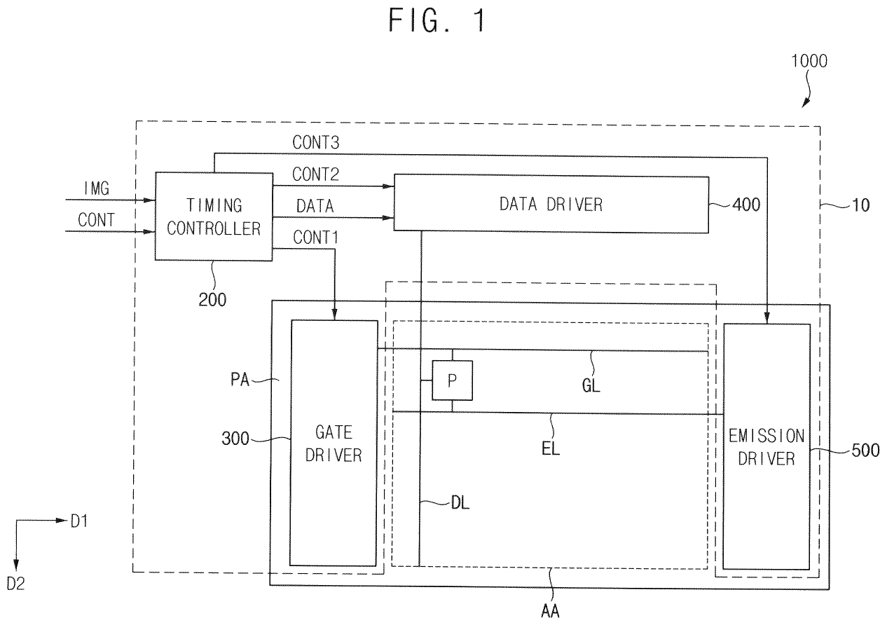

FIG. 1 is a block diagram illustrating a display device 1000 according to embodiments of the invention.

Referring to FIG. 1, an embodiment of the display device 1000 may include a display panel 100 and a display panel driver 10. The display panel driver 10 may include a timing controller 200, a gate driver 300, a data driver 400, and a emission driver 500. In an embodiment, the timing controller 200 and the data driver 400 may be integrated into a single chip.

The display panel 100 has a display region AA on which an image is displayed and a peripheral region PA adjacent to the display region AA. In an embodiment, the gate driver 300 and the emission driver 500 may be mounted on the peripheral region PA of the display panel 100.

The display panel 100 may include a plurality of gate lines GL, a plurality of data lines DL, a plurality of emission lines EL, and a plurality of pixels P electrically connected to the data lines DL, the gate lines GL, and the emission lines EL. The gate lines GL and the emission lines EL may extend in a first direction D1 and the data lines DL may extend in a second direction D2 crossing the first direction D1.

The timing controller 200 may receive input image data IMG and an input control signal CONT from a host processor, e.g., a graphic processing unit (GPU). In an embodiment, for example, the input image data IMG may include red image data, green image data and blue image data. In an embodiment, the input image data IMG may further include white image data. In an alternative embodiment, for example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The timing controller 200 may generate a first control signal CONT1, a second control signal CONT2, a third control signal CONT3, and data signal DATA based on the input image data IMG and the input control signal CONT.

The timing controller 200 may generate the first control signal CONT1 for controlling operation of the gate driver 300 based on the input control signal CONT and output the first control signal CONT1 to the gate driver 300. The first control signal CONT1 may include a vertical start signal and a gate clock signal.

The timing controller 200 may generate the second control signal CONT2 for controlling operation of the data driver 400 based on the input control signal CONT and output the second control signal CONT2 to the data driver 400. The second control signal CONT2 may include a horizontal start signal and a load signal.

The timing controller 200 may generate the third control signal CONT3 for controlling operation of the emission driver 500 based on the input control signal CONT and output the third control signal CONT3 to the emission driver 500. The third control signal CONT3 may include a vertical start signal and a emission clock signal.

The timing controller 200 may receive the input image data IMG and the input control signal CONT, and generate the data signal DATA. The timing controller 200 may output the data signal DATA to the data driver 400.

The gate driver 300 may generate gate signals for driving the gate lines GL in response to the first control signal CONT1 input from the timing controller 200. The gate driver 300 may output the gate signals to the gate lines GL. In an embodiment, for example, the gate driver 300 may sequentially output the gate signals to the gate lines GL.

The data driver 400 may receive the second control signal CONT2 and the data signal DATA from the timing controller 200. The data driver 400 may convert the data signal DATA into data voltages having an analog type. The data driver 400 may output the data voltage to the data lines DL.

The emission driver 500 may generate gate signals for driving the emission lines EL in response to the third control signal CONT3 input from the timing controller 200. The emission driver 500 may output the emission signals to the emission lines EL. In an embodiment, for example, the emission driver 500 may sequentially output the emission signals to the emission lines EL.

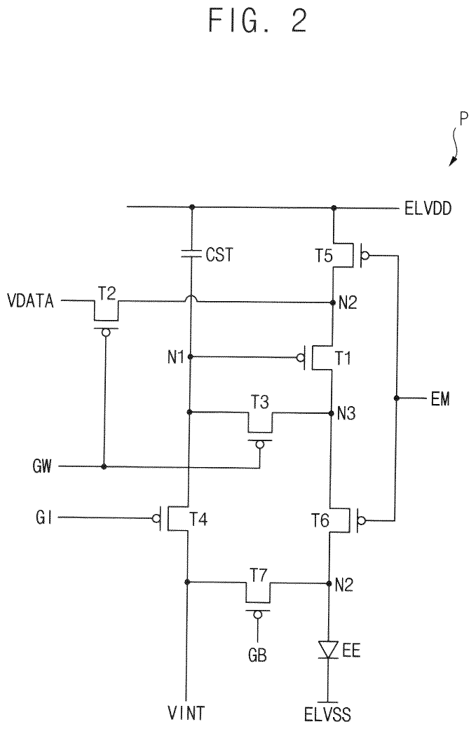

FIG. 2 is a circuit diagram illustrating an embodiment of the pixels P of the display device 1000 of FIG. 1.

Referring to FIG. 2, in an embodiment, each of the pixels P may include a first transistor T1 (i.e., a driving transistor) including a control electrode connected to a first node N1, a first electrode connected to a second node N2, and a second electrode connected to a third node N3, a second transistor T2 including a control electrode that receives a write gate signal GW, a first electrode that receives the data voltages VDATA, and a second electrode connected to the second node N2, a third transistor T3 including a control electrode that receives the write gate signal GW, a first electrode connected to the third node N3, and a second electrode connected to the first node N1, a fourth transistor T4 including a control electrode that receives an initialization gate signal GI, a first electrode that receives an initialization voltage VINT, and a second electrode connected to the first node N1, a fifth transistor T5 including a control electrode that receives the emission signal EM, a first electrode that receives a first power voltage ELVDD (e.g., a high power voltage), and a second electrode connected to the second node N2, a sixth transistor N6 including a control electrode that receives the emission signal EM, a first electrode connected to the third node N3, and a second electrode connected to a fourth node N4, a seventh transistor T7 including a control electrode that receives a bias gate signal GB, a first electrode that receives the initialization voltage VINT, and a second electrode connected to the fourth node N4, a storage capacitor CST including a first electrode that receives the first power voltage ELVDD and a second electrode connected to the first node N1, and a light emitting element EE including a first electrode connected to the fourth node N4 and a second electrode that receives a second power voltage ELVDD (e.g., a low power voltage).

In an embodiment, the first to seventh transistors T1, T2, T3, T4, T5, T6, and T7 may be p-type transistors. However, the invention is not limited thereto. In an alternative embodiment, for example, the first to seventh transistors T1, T2, T3, T4, T5, T6, and T7 may be n-type transistors.

In an embodiment, the third transistor T3 may have a dual structure. In an embodiment, the fourth transistor T4 may have the dual structure.

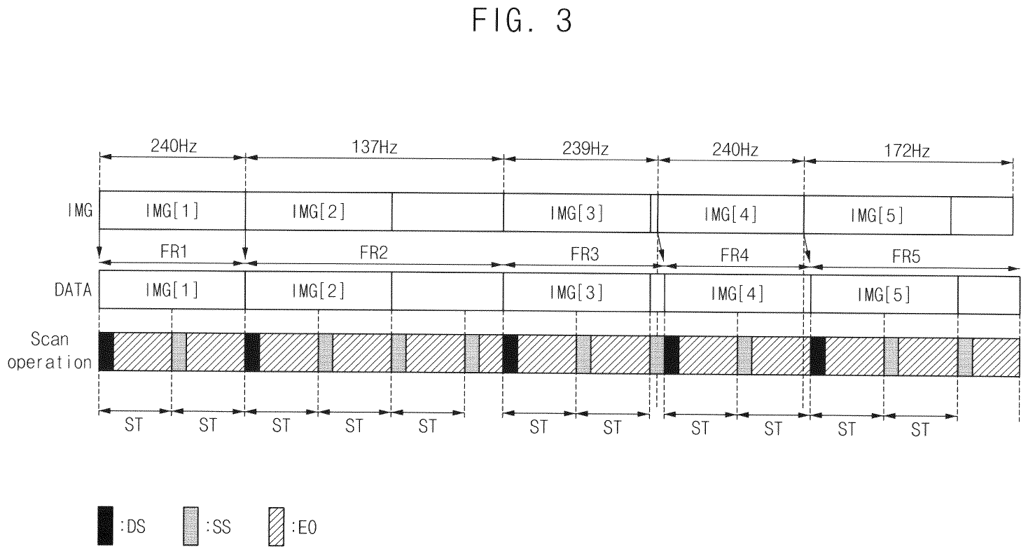

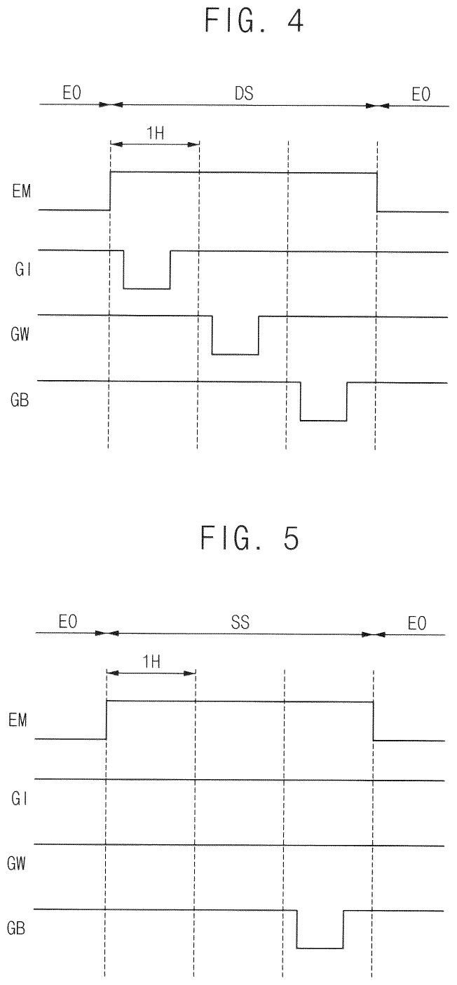

FIG. 3 is a diagram illustrating an example in which the display device 1000 of FIG. 1 varies a driving frequency, FIG. 4 is a signal timing diagram illustrating an example in which the display device 1000 of FIG. 1 performs a display scan operation DS, and FIG. 5 is a signal timing diagram illustrating an example in which the display device 1000 of FIG. 1 performs a self-scan operation SS. FIGS. 4 and 5 show an activation level as a low voltage level and an inactivation level as a high voltage level.

Referring to FIGS. 1 to 4, in an embodiment, the display panel driver 10 may perform a scan operation DS and SS and a light emission operation EO to drive the display panel 100 in the one frame. In an embodiment, for example, the display panel driver 10 may perform the light emitting operation EO between the scan operations DS and SS.

The scan operation DS and SS first performed in the one frame may be the display scan operation DS in which the data voltages VDATA are written to the pixels P, and the scan operation DS and SS excluding the display scan operation DS may be the self-scan operation SS in which the data voltages VDATA are not written to the pixels P. Detailed features of the display scan operation DS, the self-scan operation SS, and the light emission operation EO will be described later.

The display panel driver 10 may start the scan operation DS and SS in synchronization with an input timing of the input image data IMG, perform the scan operation DS and SS every a scan cycle ST in one frame, and delay a start of the scan operation DS and SS of an (N+1)-th frame until the scan operation DS and SS of an N-th frame ends when the input image data IMG of the (N+1)-th frame is input during the scan operation DS and SS of the N-th frame, where N is a positive integer. The display panel driver 10 may delay a start of the scan operation DS and SS of an (N+2)-th frame until a frame time of the (N+1)-th frame ends when the input image data IMG of the (N+2)-th frame is input in the (N+1)-th frame in which the start of the scan operation DS and SS is delayed.

The frame time of a current frame may be a time from the input timing of the input image data IMG of the current frame to the input timing of the input image data IMG of a next frame. In an embodiment, for example, the frame time of the (N+1)-th frame may be a time from the input timing of the input image data IMG of the (N+1)-th frame to the input timing of the input image data IMG of the (N+2)-th frame.

The display panel driver 10 may synchronize the driving frequency of the display panel 100 with an input frequency of the input image data IMG (i.e., operate in a variable frame mode). Accordingly, a length of one frame may not be an integer multiple of the scan cycle ST, such that an expressible driving frequency of the display panel driver 10 may be expanded or less limited.

The timing controller 200 may receive the vertical synchronizing signal together with the input image data IMG, and perform the scan operation DS and SS in synchronization with the vertical synchronizing signal. The timing controller 200 may output the data signal DATA in synchronization with the input timing of the input image data IMG. The data driver 400 may apply the data voltages VDATA converted from the data signal DATA into analog voltages to the pixels to perform the display scan operation DS.

The timing controller 200 may delay a generation of the data signal DATA for the input image data IMG until the scan operation DS and SS of the N-th frame ends when the input image data IMG of the (N+1)-th frame is input during the scan operation DS and SS of the N-th frame. In an embodiment, for example, the timing controller 200 may temporarily store the input image data IMG using a memory device (not shown) until the scan operation DS and SS of the N-th frame ends. In an embodiment, for example, the memory device may be a buffer, and the buffer may delay the input image data IMG until the scan operation DS and SS of the N-th frame ends. Since the memory device stores the input image data IMG during the scan operation DS and SS, a size of the memory device may correspond to a scan time of the scan operation DS and SS. In an embodiment, for example, when the scan time of the scan operation DS and SS are 3 horizontal times, the size of the memory device may be the size of the input image data IMG for 3 pixel lines. Here, one horizontal time 1H may be a time for writing the data voltages VDATA in one pixel line or one pixel row.

In an embodiment, as described above, the length of one frame may not be an integer multiple of the scan cycle ST. When the length of one frame is an integer multiple of the scan cycle ST, the size of the memory device may be larger than the size corresponding to the scan time of the scan operation DS and SS. Accordingly, the display panel driver 10 may use the memory device having a size corresponding to the scan time of the scan operation DS and SS to reduce memory usage.

The scan cycle ST may be a period obtained by dividing a period of a frame driven at a maximum driving frequency by M, where M is a positive integer. In an embodiment, for example, as shown in FIG. 3, the display panel driver 10 may perform one display scan operation DS and one self-scan operation SS in the frame driven at the maximum driving frequency. In this case, M may be 2. However, the invention is not limited thereto. In an alternative embodiment, for example, the display panel driver 10 may perform one display scan operation DS and zero self-scan operation SS in the frame driven at the maximum driving frequency. In this case, M may be 1.

Hereinafter, for convenience of description, embodiments where M is 2 and the maximum driving frequency is 240 Hz as shown in FIG. 3 will be described in detail.

In an embodiment, for example, the display panel driver 10 may generate the data signal DATA for the input image data IMG in synchronization with the input timing of the input image data IMG[1] of the first frame FR1 and perform the display scan operation DS. In addition, the display panel driver 10 may perform the self-scan operation SS every scan cycle ST before the input timing of the input image data IMG[2] of the second frame FR2. Accordingly, the driving frequency of the first frame FR1 may be 240 hertz (Hz), which is the input frequency of the first frame FR1.

In an embodiment, for example, the display panel driver 10 may generate the data signal DATA for the input image data IMG in synchronization with the input timing of the input image data IMG[2] of the second frame FR2 and perform the display scan operation DS. In addition, the display panel driver 10 may perform the self-scan operation SS every scan cycle ST before the input timing of the input image data IMG[3] of the third frame FR3. The same operation is performed even while the input image data IMG is not input (i.e., because the data voltages VDATA are not written in the self-scan operation SS). Accordingly, the driving frequency of the second frame FR2 may be 137 Hz, which is the input frequency of the second frame FR2.

In an embodiment, for example, the display panel driver 10 may generate the data signal DATA for the input image data IMG in synchronization with the input timing of the input image data IMG[3] of the third frame FR3 and perform the display scan operation DS. In addition, the display panel driver 10 may perform the self-scan operation SS every scan cycle ST before the input timing of the input image data IMG[4] of the fourth frame FR4. The same operation is performed even while the input image data IMG is not input. However, when the input image data IMG[4] of the fourth frame FR4 is input during the self-scan operation SS, the display panel driver 10 may not generate the data signal DATA for the input image data IMG[4] of the fourth frame FR4, and not perform the display scan operation DS until the self-scan operation SS ends. Accordingly, the driving frequency of the third frame FR3 may be slightly greater than 239 Hz, which is the input frequency of the third frame FR3.

In an embodiment, for example, the display panel driver 10 may generate the data signal DATA for the input image data IMG in synchronization with the input timing of the input image data IMG[4] of the fourth frame FR4 and perform the display scan operation DS. In addition, the display panel driver 10 may perform the self-scan operation SS every scan cycle ST before the input timing of the input image data IMG[5] of the fifth frame FR5. However, when the input image data IMG[5] of the fifth frame FR5 is input in the fourth frame FR4 in which the start of the display scan operation DS is delayed, the display panel driver 10 may delay the start of the display scan operation DS of the fifth frame FR5 until the frame time of the fourth frame FR4 ends. Accordingly, the driving frequency of the fourth frame FR4 may be 240 Hz, which is the input frequency of the fourth frame FR4.

Referring to FIGS. 2 and 4, the initialization gate signal GI, the write gate signal GW, and the bias gate signal GB may have an activation level period in the display scan operation DS. In an embodiment, for example, the fourth transistor T4 may apply the initialization voltage VINT to the control electrode (i.e., the first node N1) of the first transistor T1 in response to the initialization gate signal GI. Accordingly, the control electrode of the first transistor T1 may be initialized. In an embodiment, for example, the second transistor T2 and the third transistor T3 may write the data voltages VDATA to the storage capacitor CST in response to the write gate signal GW. In an embodiment, for example, the seventh transistor T7 may apply the initialization voltage VINT to the first electrode (i.e., the fourth node N4) of the light emitting element EE in response to the bias gate signal GB. Accordingly, the first electrode of the light emitting element EE may be initialized. Here, the activation level period may be a period having the activation level.

The emission signal EM may have the inactivation level in the scan operation DS and SS and the activation level in the light emission operation EO. Accordingly, the data voltages VDATA may be written in the display scan operation DS, and a driving current corresponding to the data voltages VDATA may flow to the light emitting element EE in the light emission operation EO. In addition, the light emitting element EE may emit light by the driving current.

Referring to FIGS. 2 and 5, the initialization gate signal GI and the write gate signal GW may have inactivation level in the self-scan operation SS, and the bias gate signal GB may have the activation level period in the self-scan operation SS. In an embodiment, for example, the seventh transistor T7 may apply the initialization voltage VINT to the first electrode of the light emitting element EE in response to the bias gate signal GB. Accordingly, the first electrode of the light emitting element EE may be initialized. Also, since the second transistor T2, the third transistor T3, and the fourth transistor T4 are turned off, the data voltages VDATA written in the storage capacitor CST may be maintained.

The emission signal EM may have the inactivation level in the scan operation DS and SS and the activation level in the light emission operation EO. Accordingly, in the self-scan operation SS, the data voltages VDATA written in the display scan operation DS may be maintained, and a driving current corresponding to the data voltages VDATA may be flow to the light emitting element EE in the light-emitting operation EO. In addition, the light emitting element EE may emit light by the driving current.

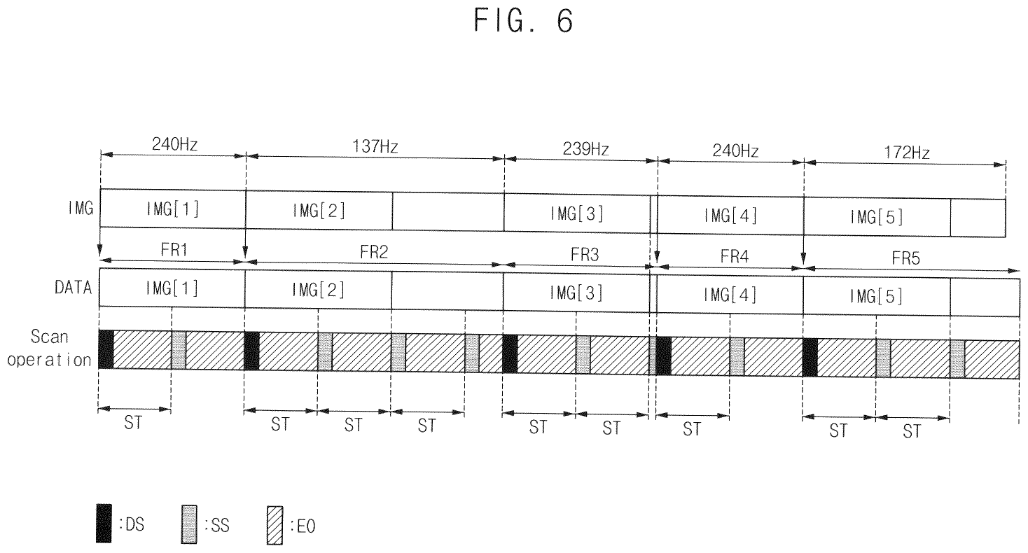

FIG. 6 is a diagram illustrating an example in which a display device varies a driving frequency according to embodiments of the invention.

The display device shown in FIG. 6 is substantially the same as the display device 1000 of FIG. 1 except for a case where the input image data IMG of the next frame is input during the scan operation DS and SS. Thus, the same reference numerals are used to refer to the same or similar element, and any repetitive detailed description thereof will be omitted.

Referring to FIGS. 1 and 6, in an embodiment, the display panel driver 10 may start the scan operation DS and SS in synchronization with the input timing of the input image data IMG, perform the scan operation DS and SS every the scan cycle ST in one frame, and start the scan operation DS and SS of the (N+1)-th frame when the input image data IMG of the (N+1)-th frame is input during the scan operation DS and SS of the N-th frame. Accordingly, the display device according to the embodiment shown in FIG. 6 may not use a memory for delay, and thus memory usage may be further reduced.

In an embodiment, for example, the display panel driver 10 may generate the data signal DATA in synchronization with the input timing of the input image data IMG[3] of the third frame FR3 and perform the display scan operation DS. In addition, the display panel driver 10 may perform the self-scan operation SS every scan cycle ST before the input timing of the input image data IMG[4] of the fourth frame FR4. The same operation is performed even while the input image data IMG is not input. However, when the input image data IMG[4] of the fourth frame FR4 is input during the self-scan operation SS, the display panel driver 10 ends the self-scan operation SS, generate the data signal DATA for the input image data IMG[4] of the fourth frame FR4, and perform the display scan operation DS. Accordingly, the driving frequency of the third frame FR3 may be 239 Hz, which is the input frequency of the third frame FR3.

In an embodiment, for example, the display panel driver 10 may generate the data signal DATA for the input image data IMG in synchronization with the input timing of the input image data IMG[4] of the fourth frame FR4, and perform the display scan operation DS. In addition, the display panel driver 10 may perform the self-scan operation SS every scan cycle ST before the input timing of the input image data IMG[5] of the fifth frame FR5. Accordingly, the driving frequency of the fourth frame FR4 may be 240 Hz, which is the input frequency of the fourth frame FR4.

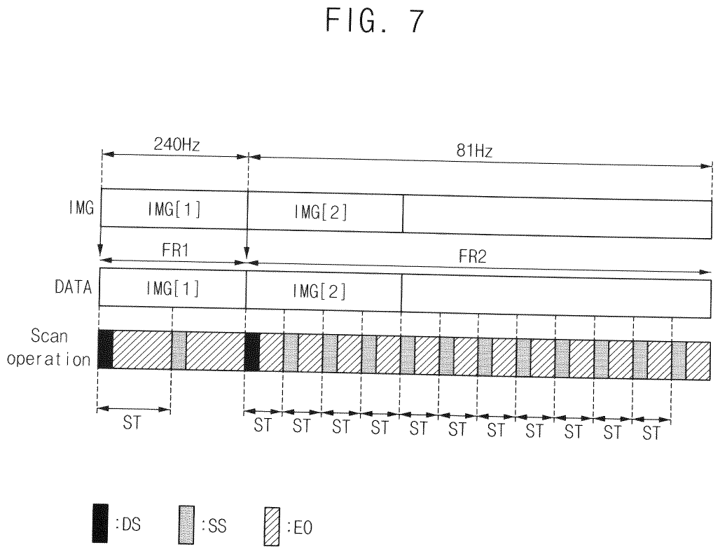

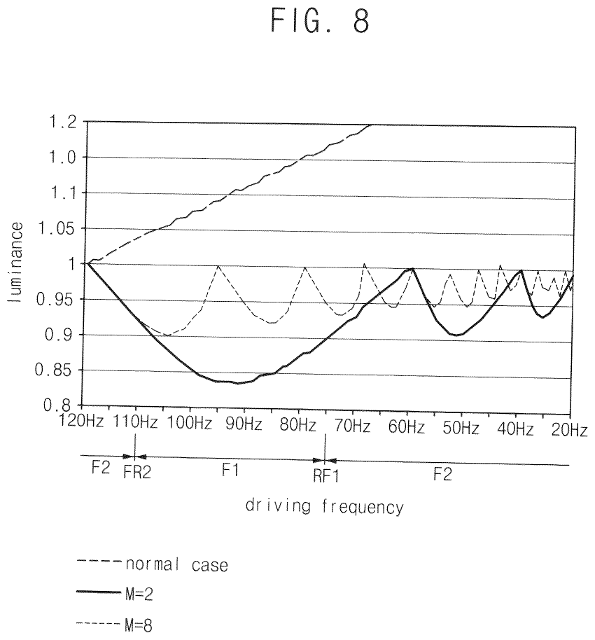

FIG. 7 is a diagram illustrating an example of the scan cycle ST of a display device according to embodiments of the invention, and FIG. 8 is a graph illustrating an example of luminance according to the driving frequency. The luminance of FIG. 8 represents a relative value.

The display device shown in FIGS. 7 and 8 is substantially the same as the display device 1000 of FIG. 1 except for compensating for a variable driving frequency. Thus, the same reference numerals are used to refer to the same or similar element, and any repetitive detailed description thereof will be omitted.

Referring to FIGS. 7 and 8, in an embodiment, the scan cycle ST may be a period obtained by dividing a period of a frame driven at the maximum driving frequency by M. The scan cycle ST when the input frequency of the input image data IMG is a first frequency F1 is shorter than the scan cycle ST when the input frequency is a second frequency F2 different from the first frequency F1. The first frequency F1 may be greater than a first reference frequency RF1 and less than or equal to a second reference frequency RF2 greater than the first reference frequency RF1. The second frequency F2 may be less than or equal to the first reference frequency RF1 or greater than the second reference frequency RF2.

In an embodiment, as shown in FIG. 8, the first reference frequency RF1 is 75 Hz and the second reference frequency RF2 is 110 Hz. The input frequency of the first frame FR1 may be 240 Hz greater than 110 Hz. That is, the input frequency of the first frame FR1 may be the second frequency F2. The input frequency of the second frame may be 81 Hz less than or equal to 110 Hz and greater than 75 Hz. That is, the input frequency of the second frame FR2 may be the first frequency F1. Accordingly, M of the first frame FR1 may be 2, and M of the second frame FR2 may be 4. That is, the scan cycle ST of the second frame FR2 may be shorter than the scan cycle ST of the first frame FR1.

As shown in FIG. 8, when the self-scan operation SS is performed, the luminance may be decreased compared to a case where only one display scan operation DS is performed without the self-scan operation SS (i.e., a normal case of FIG. 8). In addition, when the driving frequency is changed, the luminance may be reduced according to the driving frequency. In particular, a difference in the luminance may be large in a certain frequency range (e.g., the first frequency F1). However, the luminance reduction (or reduced amount or degree of the luminance) may decrease as the number of scan operations DS and SS increases in one frame. That is, as the M increases, the luminance reduction may decrease. Accordingly, by reducing the scan cycle ST when the input frequency is the first frequency F1, the display device may reduce the difference in the luminance according to the driving frequency.

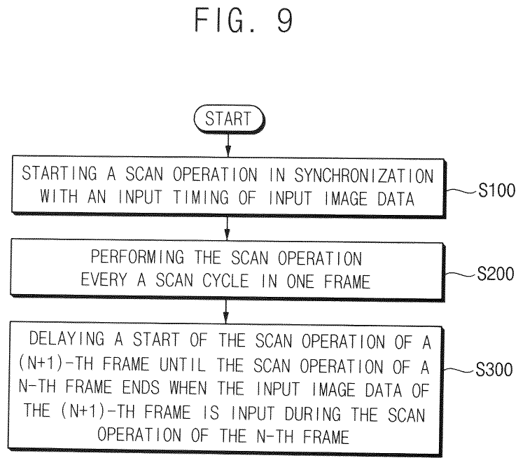

FIG. 9 is a flowchart illustrating a method of driving a display device according to embodiments of the invention.

Referring to FIG. 9, the method of driving a display device may include starting the scan operation in synchronization with the input timing of the input image data (S100), performing the scan operation every the scan cycle in one frame (S200), and delaying the start of the scan operation of the (N+1)-th frame until the scan operation of the N-th frame ends when the input image data of the (N+1)-th frame is input during the scan operation of the N-th frame (S300).

In such an embodiment, as described above, the method may include starting the scan operation in synchronization with the input timing of the input image data (S100), and performing the scan operation every the scan cycle in one frame (S200). The display panel driver may perform the scan operation and the light emission operation to drive the display panel in the one frame. The scan cycle may be a period obtained by dividing a period of a frame driven at the maximum driving frequency by M. The scan operation first performed in the one frame may be the display scan operation in which the data voltages are written to the pixels, and the scan operation excluding the display scan operation may be the self-scan operation in which the data voltages are not written to the pixels.

In an embodiment, the scan cycle when the input frequency of the input image data is the first frequency may be shorter than the scan cycle when the input frequency is the second frequency different from the first frequency. The first frequency may be greater than the first reference frequency and less than or equal to the second reference frequency greater than the first reference frequency, and the second frequency may be less than or equal to the first reference frequency or greater than the second reference frequency.

In such an embodiment, as shown in FIG. 9, the method may [symbol] include delaying the start of the scan operation of the (N+1)-th frame until the scan operation of the N-th frame ends when the input image data of the (N+1)-th frame is input during the scan operation of the N-th frame (S300). In an embodiment, the display panel driver may delay the start of the scan operation of the (N+2)-th frame until the frame time of the (N+1)-th frame ends when the input image data of the (N+2)-th frame is input in the (N+1)-th frame in which the start of the scan operation is delayed.

In an alternative embodiment, the method of FIG. 9 may start the scan operation of the (N+1)-th frame when the input image data of the (N+1)-th frame is input during the scan operation of the N-th frame.

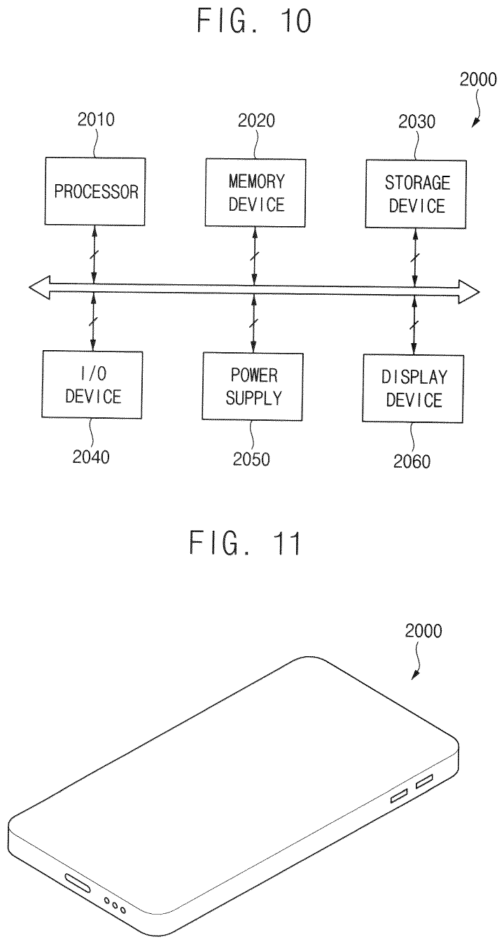

FIG. 10 is a block diagram showing an electronic device according to embodiments of the invention, and FIG. 11 is a diagram showing an embodiment in which the electronic device of FIG. 10 is implemented as a smart phone.

Referring to FIGS. 10 and 11, an embodiment of the electronic device 2000 may include a processor 2010, a memory device 2020, a storage device 2030, an input/output (I/O) device 2040, a power supply 2050, and a display device 2060. Here, the display device 2060 may be the display device 1000 of FIG. 1. In addition, the electronic device 2000 may further include a plurality of ports for communicating with a video card, a sound card, a memory card, a universal serial bus (USB) device, other electronic devices, etc. In an embodiment, as shown in FIG. 11, the electronic device 2000 may be implemented as a smart phone. However, the electronic device 2000 is not limited thereto. In an alternative embodiment, for example, the electronic device 2000 may be implemented as a cellular phone, a video phone, a smart pad, a smart watch, a tablet personal computer (PC), a car navigation system, a computer monitor, a laptop, a head mounted display (HMD) device, etc.

The processor 2010 may perform various computing functions. The processor 2010 may be a micro processor, a central processing unit (CPU), an application processor (AP), etc. The processor 2010 may be coupled to other components via an address bus, a control bus, a data bus, etc. Further, the processor 2010 may be coupled to an extended bus such as a peripheral component interconnection (PCI) bus.

The memory device 2020 may store data for operations of the electronic device 2000. In an embodiment, for example, the memory device 2020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile DRAM device, etc.

The storage device 2030 may include a solid state drive (SSD) device, a hard disk drive (HDD) device, a CD-ROM device, etc.

The I/O device 2040 may include an input device such as a keyboard, a keypad, a mouse device, a touch pad, a touch screen, etc, and an output device such as a printer, a speaker, etc. In some embodiments, the I/O device 2040 may include the display device 2060.

The power supply 2050 may provide power for operations of the electronic device 2000. In an embodiment, for example, the power supply 2050 may be a power management integrated circuit (PMIC).

The display device 2060 may display an image corresponding to visual information of the electronic device 2000. In an embodiment, for example, the display device 2060 may be an organic light emitting display device or a quantum dot light emitting display device, but is not limited thereto. The display device 2060 may be coupled to other components via the buses or other communication links. Here, the display device 2060 may synchronize the driving frequency with the input frequency. Accordingly, the expressible driving frequency of the display device may be expanded or less limited.

Embodiments of the inventions may be applied to any electronic device including the display device. In an embodiment, for example, the inventions may be applied to a television (TV), a digital TV, a 3D TV, a mobile phone, a smart phone, a tablet computer, a virtual reality (VR) device, a wearable electronic device, a personal PC, a home appliance, a laptop computer, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel including pixels; and
a display panel driver which starts a scan operation in synchronization with an input timing of input image data, performs the scan operation every a scan cycle in one frame, and delays a start of the scan operation of an (N+1)-th frame until the scan operation of an N-th frame ends when the input image data of the (N+1)-th frame is input during the scan operation of the N-th frame, wherein N is a positive integer.

2. The display device of claim 1, wherein the display panel driver delays a start of the scan operation of an (N+2)-th frame until a frame time of the (N+1)-th frame ends when the input image data of the (N+2)-th frame is input in the (N+1)-th frame in which the start of the scan operation is delayed.

3. The display device of claim 1, wherein the display panel driver performs the scan operation and a light emission operation to drive the display panel in the one frame.

4. The display device of claim 1, wherein the scan cycle is a period obtained by dividing a period of a frame driven at a maximum driving frequency by M, wherein M is a positive integer.

5. The display device of claim 1, wherein the scan cycle when an input frequency of the input image data is a first frequency is shorter than the scan cycle when the input frequency is a second frequency different from the first frequency.

6. The display device of claim 5, wherein the first frequency is greater than a first reference frequency and less than or equal to a second reference frequency, which is greater than the first reference frequency, and
wherein the second frequency is less than or equal to the first reference frequency, or greater than the second reference frequency.

7. The display device of claim 1, wherein the scan operation first performed in the one frame is a display scan operation in which data voltages are written to the pixels, and
wherein the scan operation in the one frame excluding the display scan operation is a self-scan operation in which the data voltages are not written to the pixels.

8. The display device of claim 7, wherein each of the pixels includes:
a first transistor including a control electrode connected to a first node, a first electrode connected to a second node, and a second electrode connected to a third node;
a second transistor including a control electrode which receives a write gate signal, a first electrode which receives the data voltages, and a second electrode connected to the second node;
a third transistor including a control electrode which receives the write gate signal, a first electrode connected to the third node, and a second electrode connected to the first node;
a fourth transistor including a control electrode which receives an initialization gate signal, a first electrode which receives an initialization voltage, and a second electrode connected to the first node;
a fifth transistor including a control electrode which receives an emission signal, a first electrode which receives a first power voltage, and a second electrode connected to the second node;
a sixth transistor including a control electrode which receives the emission signal, a first electrode connected to the third node, and a second electrode connected to a fourth node;
a seventh transistor including a control electrode which receives a bias gate signal, a first electrode which receives the initialization voltage, and a second electrode connected to the fourth node;
a storage capacitor including a first electrode which receives the first power voltage and a second electrode connected to the first node; and
a light emitting element including a first electrode connected to the fourth node and a second electrode which receives a second power voltage.

9. The display device of claim 8, wherein the emission signal has a inactivation level in the scan operation and an activation level in a light emission operation.

10. The display device of claim 8, wherein the write gate signal and the initialization gate signal have an activation level period in the display scan operation and an inactivation level in the self-scan operation, and
wherein the bias gate signal has an activation level period in the display scan operation and the self-scan operation.

11. A display device comprising:
a display panel including pixels; and
a display panel driver which starts a scan operation in synchronization with an input timing of input image data, performs the scan operation every a scan cycle in one frame, and starts the scan operation of an (N+1)-th frame when the input image data of the (N+1)-th frame is input during the scan operation of an N-th frame, wherein N is a positive integer.

12. The display device of claim 11, wherein the display panel driver performs the scan operation and a light emission operation to drive the display panel in the one frame.

13. The display device of claim 11, wherein the scan cycle is a period obtained by dividing a period of a frame driven at a maximum driving frequency by M, where M is a positive integer.

14. The display device of claim 11, wherein the scan cycle when an input frequency of the input image data is a first frequency is shorter than the scan cycle when the input frequency is a second frequency different from the first frequency.

15. The display device of claim 14, wherein the first frequency is greater than a first reference frequency and less than or equal to a second reference, which is frequency greater than the first reference frequency, and
wherein the second frequency is less than or equal to the first reference frequency, or greater than the second reference frequency.

16. The display device of claim 11, wherein the scan operation first performed in the one frame is a display scan operation in which data voltages are written to the pixels, and
wherein the scan operation in the one frame excluding the display scan operation is a self-scan operation in which the data voltages are not written to the pixels.

17. The display device of claim 16, wherein each of the pixels includes:
a first transistor including a control electrode connected to a first node, a first electrode connected to a second node, and a second electrode connected to a third node;
a second transistor including a control electrode which receives a write gate signal, a first electrode which receives the data voltages, and a second electrode connected to the second node;
a third transistor including a control electrode which receives the write gate signal, a first electrode connected to the third node, and a second electrode connected to the first node;
a fourth transistor including a control electrode which receives an initialization gate signal, a first electrode which receives an initialization voltage, and a second electrode connected to the first node;
a fifth transistor including a control electrode which receives an emission signal, a first electrode which receives a first power voltage, and a second electrode connected to the second node;
a sixth transistor including a control electrode which receives the emission signal, a first electrode connected to the third node, and a second electrode connected to a fourth node;
a seventh transistor including a control electrode which receives a bias gate signal, a first electrode which receives the initialization voltage, and a second electrode connected to the fourth node;
a storage capacitor including a first electrode which receives the first power voltage and a second electrode connected to the first node; and
a light emitting element including a first electrode connected to the fourth node and a second electrode which receives a second power voltage.

18. The display device of claim 17, wherein the emission signal has a inactivation level in the scan operation and an activation level in a light emission operation.

19. The display device of claim 17, wherein the write gate signal and the initialization gate signal have an activation level period in the display scan operation and an inactivation level in the self-scan operation, and
wherein the bias gate signal has an activation level period in the display scan operation and the self-scan operation.

20. A method of driving a display device, the method comprising:
starting a scan operation in synchronization with an input timing of input image data;
performing the scan operation every a scan cycle in one frame;
delaying a start of the scan operation of an (N+1)-th frame until the scan operation of an N-th frame ends when the input image data of the (N+1)-th frame is input during the scan operation of the N-th frame, wherein N is a positive integer.
